(19) United States
(12) Patent Application Publication
(10) Pub. No.: US 2007/0268719 A1
(43) Pub. Date: Nov. 22, 2007

(54) Illuminated decorative article

(76) Inventor: Sheng-wen Huang, Pan Chio City (TW)

Correspondence Address: Stephen G. Rudisill;JENKENS & GILCHRIST, A PROFESSIONAL COPORATION, 225 W. Washington, Ste. 2600, Chicago, IL, 60606-3418, US

(21) Appl. No.: 11/436,479

(22) Filed: May 18, 2006

(51) Int. Cl. F21S 4/00

(52) U.S. Cl. 362/565

(57) ABSTRACT

An illuminated decorative article comprises a hollow plastic article having front and rear walls and forming a decorative shape, and multiple light sources disposed within the hollow plastic article. At least the front panel of the hollow article is transparent to transmit light from the multiple sources disposed within the article. The hollow plastic article may be formed from front and rear panels joined to each other around their periphery, e.g., by thermally bonding edge portions of the panels to each other. The multiple light sources may be provided by a single light string, and the panels may be formed from a glossy-surfaced polyvinlychloride plastic sheet or film.

### FIELD OF THE INVENTION

The present invention relates to illuminated decorative items, such as decorations for use at Christmas and other holidays.

### SUMMARY OF THE INVENTION

One embodiment of the present invention provides an illuminated decorative article comprising a hollow plastic article having front and rear walls and forming a decorative shape, and multiple light sources disposed within the hollow plastic article. At least the front panel of the hollow article is transparent to transmit light from the multiple sources disposed within the article. The hollow plastic article may be formed from front and rear panels joined to each other around their periphery, e.g., by thermally bonding edge portions of the panels to each other.

In one particular embodiment, the rear wall of the hollow article includes multiple spaced apertures, and light string bulbs that are disposed within the hollow interior of the article extend into the article through the apertures.

In another specific embodiment, at least a portion of the front surface of the rear wall of the hollow article is reflective.

One embodiment of the present invention provides a method of illuminating a hollow plastic article having front and rear walls and forming a decorative shape, by forming at least the front panel of the article from transparent material, and disposing multiple light sources within the hollow plastic article so that light from the sources is transmitted through the transparent front panel. In one implementation, the multiple light sources are provided by a light string having at some of its lights disposed within the hollow article.

### BRIEF DESCRIPTION OF THE DRAWINGS

The invention may best be understood by reference to the following description taken in conjunction with the accompanying drawings, in which:

FIG. 1 is a front elevation of an illuminated decorative article simulating a bow and embodying the invention;

FIG. 2 is a plan view of the article shown in FIG. 1 partially assembled;

FIG. 3 is a section taken along line 3-3 in FIG. 1;

FIG. 4 is a section taken along line 4-4 in FIG. 1;

FIG. 5 is a front elevation of an illuminated decorative article simulating a jack-o-lantern and embodying the invention;

FIG. 6 is a rear elevation of the article shown in FIG. 1; and

FIG. 7 is a section taken along line 7-7 in FIG. 6.

### DETAILED DESCRIPTION OF THE ILLUSTRATED EMBODIMENTS

Although the invention will be described in connection with certain preferred embodiments, it will be understood that the invention is not limited to those particular embodiments. On the contrary, the invention is intended to include all alternatives, modifications and equivalent arrangements as may be included within the spirit and scope of the invention as defined by the appended claims.

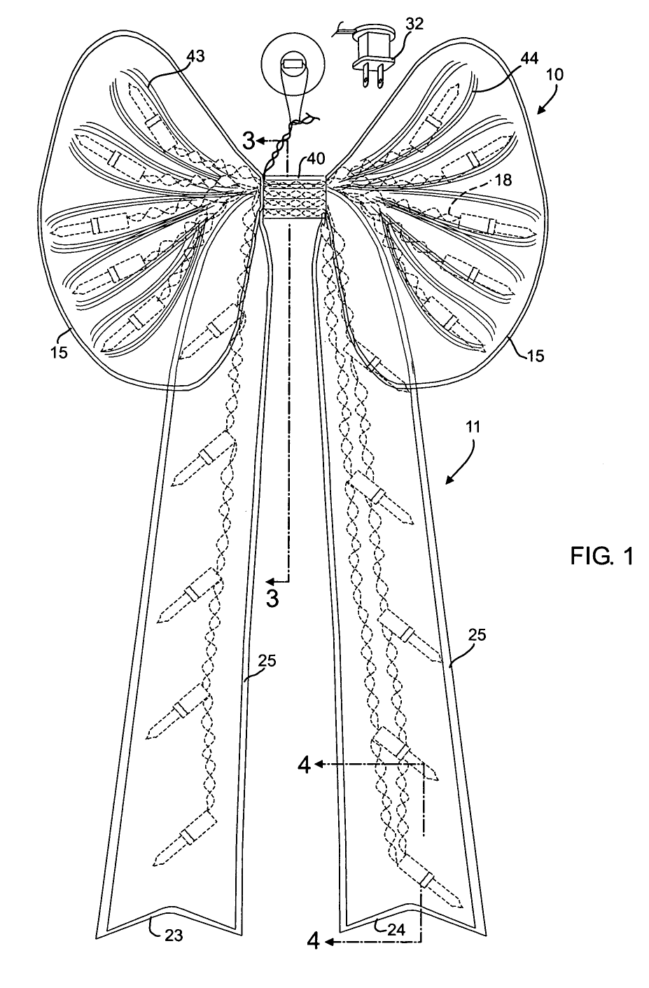

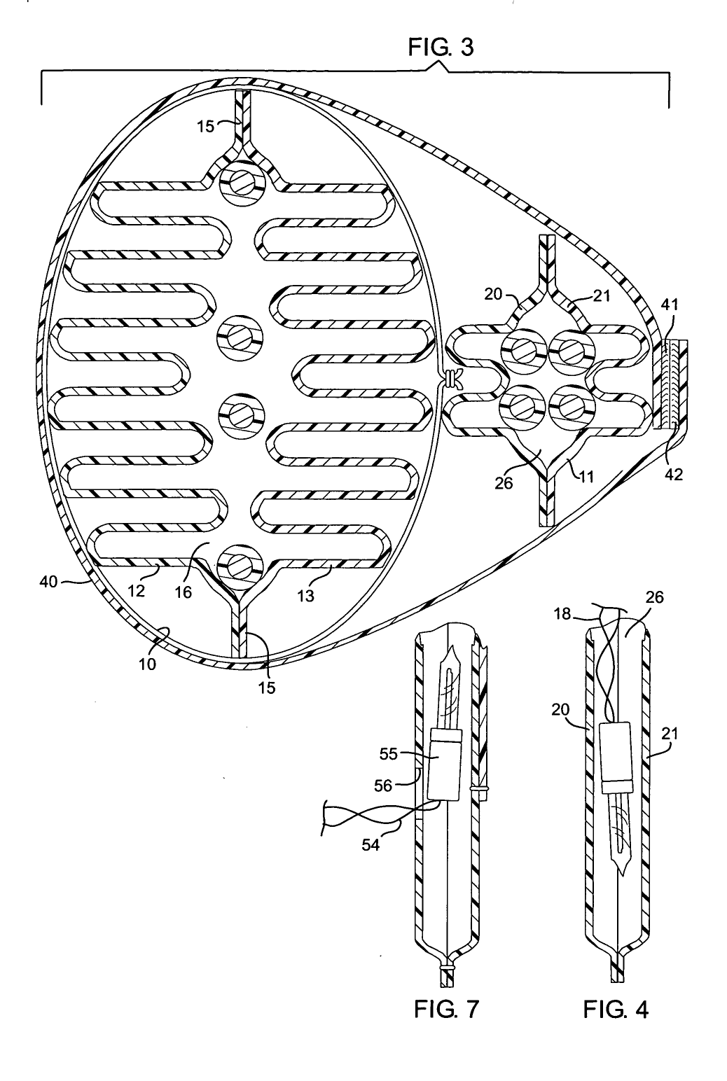

Turning now to the drawings and referring first to FIGS. 1-3, a Christmas bow is simulated by two illuminated parts 10 and 11. The upper part 10 is made by joining two plastic panels 12 and 13 (see FIG. 3) cut from a flexible plastic sheet (or sheets) in shapes that resemble the profile of the upper portion of a bow, particularly when the central portion 14 of the part 10 is squeezed together. One suitable plastic sheet or film that can be used to form the panels 12 and 13 is polyvinylchloride, which typically has an attractive glossy surface. The two panels are 12 and 13 are joined by thermally bonding outer edge portions 15 of the two panels around their entire peripheries, thereby forming a hollow interior 16 (see FIG. 3) between the two panels 12 and 13. The bonded edge portions 15 are suitably about 1/16 inch wide, extending inwardly from the peripheral edges of the plastic panels 12 and 13.

A central aperture 17 is formed in the rear panel 13 to allow a portion of a light string 18 to be inserted into the hollow interior 16 to illuminate the entire part 10. At least the front panel 12 is cut from a transparent plastic sheet so that light emitted from the light string 18 is transmitted through the front panel 12. The front panel 12 may also be colored so that it transmits only a portion of the spectrum of wavelengths emitted by the light string (e.g., red for a Christmas bow).

Other light sources may be used in place of the light string to provide the desired multiple light sources between the two panels 12 and 13. For example, multiple light sources may be provided by transmitting light from one or more sources to the space between the panels 12 and 13 through a bundle of optical fibers in which individual fibers are terminated at different locations throughout the space between the panels, so that light is emitted at all those different locations. If desired, light sources of different colors may supply light to the fiber bundle.

The lower part 11 of the bow is made by joining two plastic panels 20 and 21 cut from a plastic sheet (or sheets) in elongated, generally rectangular shapes that resemble depending end portions of a ribbon tied in a bow, particularly when the central portion 22 of the part 11 is squeezed together along with the central portion of the upper part 10 (see FIG. 1). The narrow ends of the generally rectangular panels are slightly notched, as at 23 and 24 in FIG. 1. The plastic sheet or film used to form the lower part 11 is preferably the same material used to form the upper part 10, e.g., glossy-surfaced polyvinylchloride. The two panels 20 and 21 are joined by thermally bonding outer edge portions 25 of the two panels around their entire peripheries, thereby forming a hollow interior 26 between the two panels 20 and 21.

As in the case of the upper part 10 of the bow, a central aperture 27 is formed in the rear panel 21 of the lower part 11 to allow a portion of the light string 18 to be inserted into the hollow interior 26 to illuminate the entire part 11. At least the front panel 20 is transparent so that light emitted from the light string 18 is transmitted through the front panel 20. The front panel 20 may also be colored, preferably matching the color of the upper part 10, so that it transmits only a portion of the spectrum of wavelengths emitted by the light string (e.g., red for a Christmas bow).

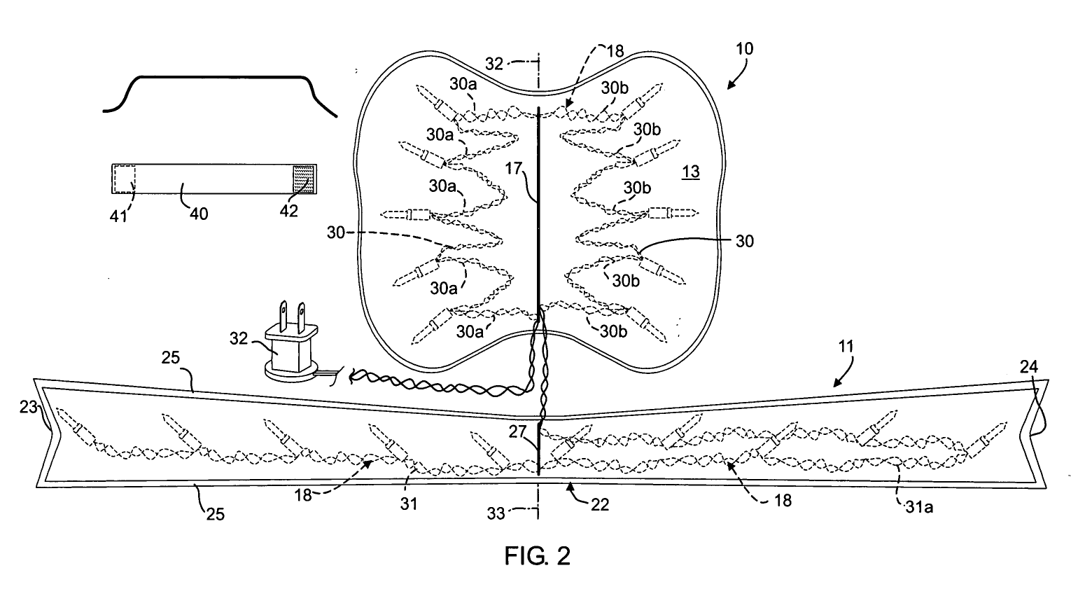

As can be seen in FIG. 2, the same light string 18 may be used to illuminate both the upper and lower parts 10 and 11 of the bow. This is accomplished by forming a loop 30 in the portion of the light string 18 that enters the upper part 10 through the central aperture 17, and another three-quarter loop 31 in the portion of the light string 18 that enters the lower part 11 through the central aperture 27. Half of the upper loop 30 is located in each half of the upper part 10, on opposite sides of a central axis of symmetry 32. Each half of the loop 30 is folded in an undulating or zig-zag pattern to form five lobes 30a or 30b, each of which has a bulb at its tip so that both halves of the upper part 10 are illuminated throughout their hollow interiors. In the lower part 11, half of the three-quarter loop 31 is located in each half of the lower part 11, on opposite sides of the axis of symmetry 33. One half of the three-quarter loop 31 is folded to form a single lobe 31a containing multiple bulbs to illuminate both halves of the lower part 11.

The only portion of the light string 18 that remains outside the two parts 10 and 11 of the bow is the end portion that terminates in a plug 32 that is used to connect the light string to a standard residential AC power source.

To assemble the multiple parts of the illustrative bow, including the light string 18 as well as the upper and lower parts 10 and 11, a strap 40 is dimensioned to fit tightly around the central portions of both the upper and lower parts 10 and 11. Mating parts 41 and 42 of a conventional hook-and-loop fastener are attached to opposite ends of the strap 40 to securely fasten the strap in a closed loop after it has been pulled tightly around the central portions of both the upper and lower parts 10 and 11 and the wires of the light string 18. Application of the strap 40 squeezes the central portions of the parts 10 and 11 tightly together to form the desired bow shape illustrated in FIG. 1. The slack provided in the segments of the light string extending between successive bulbs in the upper part 10, by the undulating pattern of the light string, helps retain the bulbs in the desired position as the central portion of the part 10 is squeezed together during application of the strap 40. As the two parts 10 and 11 are squeezed together, folds 43 and 44 are formed in the portions extending away from the strap 40, producing an aesthetic decorative effect. The strap 40 not only attaches the two parts 10 and 11 to each other, but also holds the various loops and lobes of the light string 18 securely in place in their desired configurations within the parts 10 and 11, and also conceals the access apertures 17 and 27 for the light string.

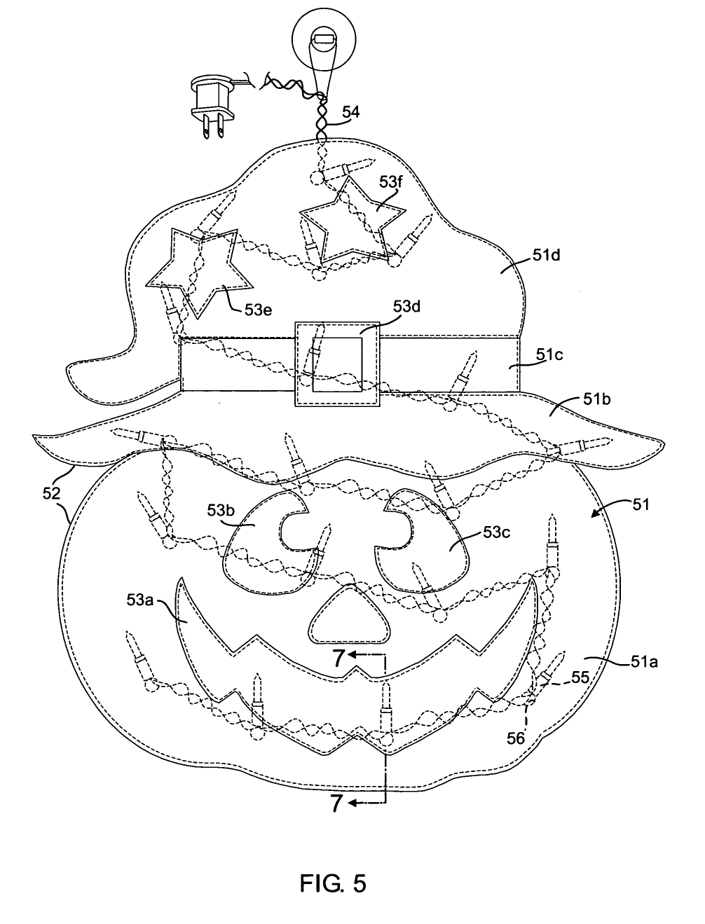

FIGS. 5-7 illustrate a second embodiment that simulates a decorated Halloween jack-o-lantern. In this embodiment, the rear panel 50 is formed by a single plastic sheet having a metallized (and optionally holographic) front surface that is highly reflective. The metallized surface may also be patterned to provide different decorative effects. The front panel 51 is formed by stitching multiple pieces 51a-51d to each other and to the periphery of the rear panel 50, as at 52. In the illustrative embodiment, piece 51a forms the main body of the jack-o-lantern and is preferably formed from an orange transparent plastic sheet. The other three pieces 51b-51d form a hat on the jack-o-lantern. Pieces 51b and 51d are suitably made of black plastic film, while piece 51c (the hat band) is suitably made from a green transparent sheet. Additional plastic pieces 53a-53g are stitched to the front surfaces of the pieces 51a-51d to provide the desired effect, namely, the face of the jack-o-lantern, and a buckle and a pair of stars on the hat. It will be understood that numerous different patterns and decorative effects may be achieved by use of the basic structures provided by this invention.

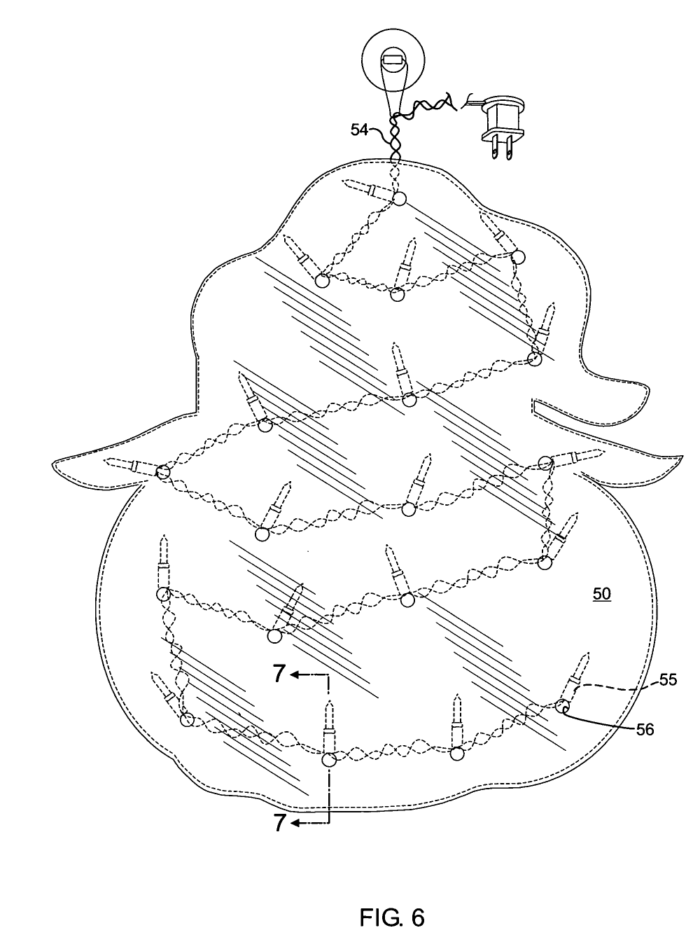

As can be seen in FIG. 6, the light string 54 used to illuminate the jack-o-lantern extends along the rear surface of the rear panel 50. Each bulb socket 55 of the light string is inserted through one of multiple apertures 56 formed in the rear panel 50 to illuminate the hollow interior formed between the one-piece rear panel 50 and the multi-piece front panel 51. As can be seen in the sectional view in FIG. 7, each bulb socket 55 is turned through an angle of about 90 degrees by the pressure of the front panel 51, after the socket has been inserted through the rear panel. This turning of the socket serves to hold the socket securely in place between the two panels 50 and 51.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. An illuminated decorative article comprising
a hollow plastic article having front and rear walls and forming a decorative shape, and
multiple light sources disposed within said hollow plastic article, at least the front panel of said article being transparent to transmit light from said light sources disposed within said article.

2. The illuminated decorative article of claim 1 wherein said multiple light sources comprise multiple optical fibers or a light string of miniature bulbs, at least some of which are disposed within said hollow plastic article.

3. The illuminated decorative article of claim 1 wherein at least said front wall is formed of polyvinlychloride film.

4. The illuminated decorative article of claim 1 wherein said rear wall includes multiple spaced apertures, and said bulbs that are disposed within the hollow interior of said article extend into said hollow interior through said apertures.

5. The illuminated decorative article of claim 1 wherein at least a portion of the front surface of said rear wall is reflective.

6. The illuminated decorative article of claim 1 wherein said hollow plastic article is formed from front and rear panels joined to each other around their periphery.

7. The illuminated decorative article of claim 6 wherein said front and rear panels are joined by thermally bonding edge portions of said front and rear panels to each other.

8. The illuminated decorative article of claim 1 wherein said decorative shape is symmetrical about an axis of symmetry, said rear wall includes at least one aperture located substantially on said axis of said symmetry, and a potion of said light string extends into said hollow interior through said aperture and extends throughout substantial portions of said hollow interior on opposite sides of said axis of symmetry.

9. The illuminated decorative article of claim 8 wherein said portion of said light string extending into said hollow interior forms at least one loop with at least one end of said light string located outside said hollow plastic article.

10. The illuminated decorative article of claim 1 wherein said transparent from wall is colored so that it transmits only a portion of the spectrum of wavelengths emitted by said bulbs disposed within said hollow interior.

11. A method of illuminating a hollow plastic article having front and rear walls and forming a decorative shape, comprising
forming at least the front panel of said article from transparent material, and
disposing multiple light sources within said hollow plastic article so that light from said sources is transmitted through said transparent front panel.

12. The method of claim 11 wherein said multiple light sources comprise multiple optical fibers or a light string of miniature bulbs, at least some of which are disposed within said hollow plastic article.

13. The method of claim 11 wherein at least said front wall is formed of polyvinlychloride film.

14. The method of claim 11 wherein said rear wall includes multiple spaced apertures, and said bulbs that are disposed within the hollow interior of said article extend into said hollow interior through said apertures.

15. The method of claim 11 wherein at least a portion of the front surface of said rear wall is reflective.

16. The method of claim 11 wherein said hollow plastic article is formed from front and rear panels joined to each other around their periphery.

17. The illuminated decorative article of claim 16 wherein said front and rear panels are joined by thermally bonding edge portions of said front and rear panels to each other.

18. The method of claim 11 wherein said decorative shape is symmetrical about an axis of symmetry, said rear wall includes at least one aperture located substantially on said axis of said symmetry, and a potion of said light string extends into said hollow interior through said aperture and extends throughout substantial portions of said hollow interior on opposite sides of said axis of symmetry.

19. The illuminated decorative article of claim 18 wherein said portion of said light string extending into said hollow interior forms at least one loop with both ends of said light string located outside said hollow plastic article.

20. The method of claim 11 wherein said transparent from wall is colored so that it transmits only a portion of the spectrum of wavelengths emitted by said bulbs disposed within said hollow interior.
